(19) United States
(12) Patent Application Publication
(10) Pub. No.: US 2026/0061476 A1
(43) Pub. Date: Mar. 5, 2026

(54) BATTERY CAN TRIMMING APPARATUS AND METHOD

(71) Applicant: SAMSUNG SDI CO., LTD., Yongin-si (KR)

(72) Inventors: YOUNGJIN JANG, Yongin-si (KR); JUNGHUN CHOI, Yongin-si (KR)

(21) Appl. No.: 19/076,004

(22) Filed: Mar. 11, 2025

(30) Foreign Application Priority Data
Sep. 4, 2024 (KR) 10-2024-0120420

(51) Int. Cl. B21D 28/28; H01M 50/103

(52) U.S. Cl. CPC B21D 28/28; H01M 50/103

(57) ABSTRACT

A battery can trimming apparatus includes a die with a first opening therethrough, a punch guide extending through the first opening of the die, the punch guide being configured to be in contact with an inner surface of a closed portion of a semi-finished battery can, and the semi-finished battery can including a surplus portion to be cut along a cutting line, the closed portion, and a second opening, a support pad above the punch guide, the support pad being configured to support an outer surface of the closed portion of the semi-finished battery can, and a punch below the die and moveable along a bottom of the die, the punch being configured to cut the surplus portion along the cutting line of the semi-finished battery can, and the cutting line being positioned at a predetermined distance from the outer surface of the closed portion of the semi-finished battery can.

### CROSS-REFERENCE TO RELATED APPLICATION

This application claims priority to and the benefit of Korean Patent Application No. 10-2024-0120420, filed on Sep. 4, 2024, the disclosure of which is incorporated herein by reference in its entirety.

### BACKGROUND

### 1. Field

The present disclosure relates to a trimming apparatus and method used for a process of manufacturing a battery can.

### 2. Description of the Related Art

In general, batteries include non-rechargeable primary batteries and rechargeable secondary batteries. A battery may include an electrode assembly composed of a positive electrode plate, a negative electrode plate, a separator, and the like. The electrode assembly may be accommodated in a can.

Cans of the secondary battery and the primary battery (hereinafter referred to as “battery”) may be manufactured by extrusion molding. A can manufacturing process may generally include an impact process of applying an impact to a slug or billet-shaped material to form the material into an approximate cup shape, an ironing process of placing a punch in an internal space in the cup shape and pushing the punch with a die inward to make a sidewall thin and even so as to improve a surface smoothly, and a trimming process of cutting redundant portions of a battery can to remove scraps and cutting the can to match its height with a design value.

The above information disclosed in this Background section is for enhancement of understanding of the background of the present disclosure, and therefore, it may contain information that does not constitute a related (or prior) art.

### SUMMARY

According to an aspect of the present disclosure, there is provided a battery can trimming apparatus including a punch guide in contact with an inner surface of a closed portion of a semi-finished battery can including a surplus portion to be cut along a cutting line, the closed portion, and an opening, a support pad that supports an outer surface of the closed portion of the semi-finished battery can; and a punch and a die punched by the punch guide to cut the surplus portion along a cutting line of the semi-finished battery can, wherein the cutting line of the surplus portion is positioned at a predetermined distance from the outer surface of the closed portion of the semi-finished battery can.

According to another aspect of the present disclosure, there is provided a battery can trimming method including placing a semi-finished battery can to bring a punch guide into contact with an inner surface of a closed portion of the semi-finished battery can including a surplus portion to be cut along a cutting line, the closed portion, and an opening, supporting an outer surface of the closed portion of the semi-finished battery can using a support pad; and cutting the surplus portion along a cutting line of the semi-finished battery can using a punch and a die, wherein the cutting line of the surplus portion is positioned at a predetermined distance from the outer surface of the closed portion of the semi-finished battery can.

Aspects and features of the present disclosure are not limited to those described above, and other aspects and features not specifically mentioned herein will be clearly understood by those skilled in the art from the description of the present disclosure below.

### BRIEF DESCRIPTION OF THE DRAWINGS

Features will become apparent to those of skill in the art by describing in detail exemplary embodiments with reference to the attached drawings, in which:

FIG. 1 is a top perspective view showing the exterior of a prismatic secondary battery according to some embodiments of the present disclosure;

FIG. 2 is a cross section along line I-I′ in FIG. 1 and shows an internal configuration of the secondary battery;

FIGS. 3A to 3C are schematic views of stages in a battery can trimming process;

FIG. 4 is an exemplary view of a general battery can trimming apparatus according to some embodiments of the present disclosure;

FIG. 5 is a configuration diagram of a battery can trimming apparatus according to some other embodiments of the present disclosure;

FIG. 6 is a configuration diagram of a battery can trimming apparatus according to still some other embodiments of the present disclosure;

FIG. 7 shows a trimming apparatus to which a support pad holder connecting a support pad and a press device is attached;

FIG. 8 shows an example of a punch guide divided into a first punch guide and a second punch guide;

FIG. 9 shows another example of a punch guide;

FIG. 10 shows a state in which a pad holder attached to a support pad is connected to a portion of a press device; and

FIG. 11 is an enlarged view of portion A in FIG. 10.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. It will further be understood that if an element or layer is referred to as being “linked to,” “connected to,” or “coupled to” another element or layer, it may be directly linked, connected, or coupled to the other element or layer or one or more intervening elements or layers may also be present. When an element or layer is referred to as being “directly linked to,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S. C. § 132(a).

References to two compared elements, features, etc. as being “the same” may mean that they are “substantially the same. ” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

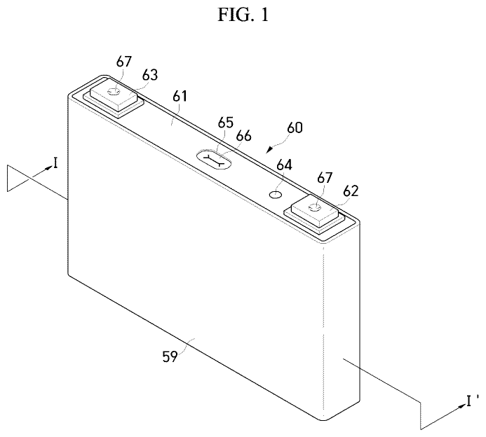

FIG. 1 is a top perspective view of a prismatic secondary battery, according to some embodiments of the present disclosure.

Referring to FIG. 1, a battery can 59 may define an overall appearance of the prismatic secondary battery, and may be made of a conductive metal, such as aluminum, aluminum alloy, or nickel-plated steel. In addition, the battery can 59 may provide a space for accommodating an electrode assembly therein.

A cap assembly 60 may include a cap plate 61 that covers the opening of the battery can 59. In some examples, the battery can 59 and the cap plate 61 may be made of a conductive material. Here, a first terminal 62 and a second terminal 63 may be electrically connected to respective positive and negative (or negative and positive) electrodes inside the battery can 59, and may be installed to protrude outward through the cap plate 61.

The cap plate 61 may be equipped with an electrolyte injection port 64 formed to install a sealing plug (or seal pin), and a vent 66 formed with a notch 65. The vent 66 is for discharging gas generated inside the secondary battery.

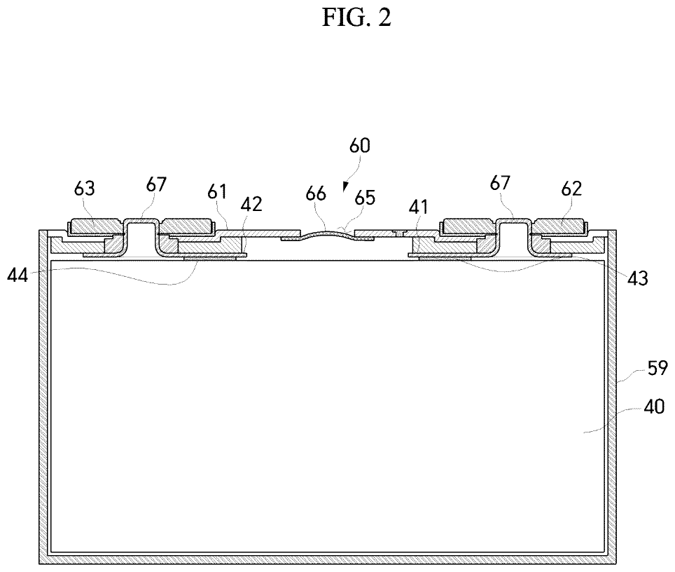

FIG. 2 is a cross-sectional view taken along line I-I′ of FIG. 1, according to some embodiments of the present disclosure. As shown, a prismatic secondary battery may include an electrode assembly 40, a first current collector 41, the first terminal 62, a second current collector 42, the second terminal 63, the battery can 59, and the cap assembly 60.

The electrode assembly 40 may be formed by winding or stacking a stack of a first electrode plate, a separator, and a second electrode plate, which are formed as thin plates or films. When the electrode assembly 40 is a wound stack, a winding axis may be parallel to the longitudinal direction of the battery can 59. In some other embodiments, the electrode assembly 40 may be a stack type rather than a winding type. In addition, the electrode assembly 40 may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure. The first electrode plate of the electrode assembly may act as a negative electrode, and the second electrode plate may act as a positive electrode, e.g., the reverse may also be possible.

The first electrode plate may be formed by applying a first electrode active material, such as graphite, carbon, or the like, to a first electrode current collector formed of a metal foil, such as copper, a copper alloy, nickel, a nickel alloy, or the like. The first electrode plate may include a first electrode tab 43 (e.g., a first uncoated portion) that is a region to which the first electrode active material is not applied. The first electrode tab 43 may act as a current flow path between the first electrode plate and the first current collector 41. In some embodiments, when the first electrode plate is manufactured, the first electrode tab 43 is formed by being cut in advance to protrude to one side of the electrode assembly 40, or the first electrode tab 43 protrudes to one side of the electrode assembly 40 more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab 44 (e.g., a second uncoated portion) that is a region to which the second electrode active material is not applied. The second electrode tab 44 may act as a current flow path between the second electrode plate and the second current collector 42. In some embodiments, the second electrode tab 44 may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

The separator prevents or substantially reduces instances of a short circuit between the first electrode and the second electrode while allowing movement of lithium ions therebetween. The separator may be made of, for example, a polyethylene film, a polypropylene film, a polyethylene-polypropylene film, or the like.

In some embodiments, the electrode assembly 40 is accommodated in the case 59 along with an electrolyte. In the electrode assembly 40, the first current collector 41 and the second current collector 42 may be welded and connected to the first electrode tab 43 extending from the first electrode plate and the second electrode tab 44 extending from the second electrode plate, respectively. As mentioned above, in some embodiments in which the first electrode tab 43 and the second electrode tab 44 are located at the top of the electrode assembly 40, the first and second current collectors are located at the top of the electrode assembly 40.

As illustrated in FIG. 2, the first current collector 41 and the second current collector 42 may be connected to the first terminal 62 and the second terminal 63 through connection members 67, respectively. In some embodiments, the connection members 67 may each have an outer peripheral surface that is threaded, and may be fastened to the first terminal 62 and the second terminal 63 by screwing. In other embodiments, the connection members 67 may also be coupled to the first terminal 62 and the second terminal 63 by riveting or welding.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel oxide, a lithium cobalt oxide, a lithium manganese oxide, a lithium iron phosphate compound, a cobalt-free nickel-manganese oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L1_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8,0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt% to about 99.5 wt% on the basis of 100 wt% of the positive electrode active material layer, and the content of the binder and the conductive material is in a range of about 0.5 wt% to about 5 wt%, respectively, on the basis of 100 wt% of the positive electrode active material layer.

The substrate may be aluminum (Al).

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x<2), a Si alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move. The non-aqueous organic solvent may be a carbonate, an ester, an ether, a ketone, an alcohol solvent, an aprotic solvent, and may be used alone or in combination of two or more. In addition, when a carbonate solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer. The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto. The organic material and the inorganic material may be mixed in one coating layer or may be in the form of a coating layer including (or containing) an organic material and a coating layer including (or containing) an inorganic material that are stacked on each other.

A battery can used in a secondary battery (or a primary battery) may be manufactured by extrusion molding. A manufacturing process generally includes an impact process of applying an impact to a slug or billet-shaped material to form the material into an approximate cup shape, an ironing process of placing a punch in an internal space in the cup shape and pushing the punch with a die inward to make a sidewall thin and even so as to improve a surface smoothly, and a trimming process of cutting redundant portions of a battery can to remove scraps, and cutting the can to match its height with a design value.

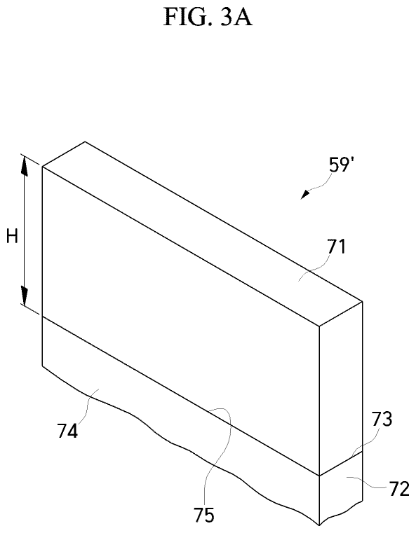

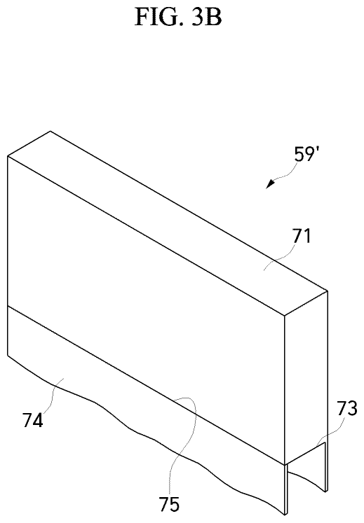

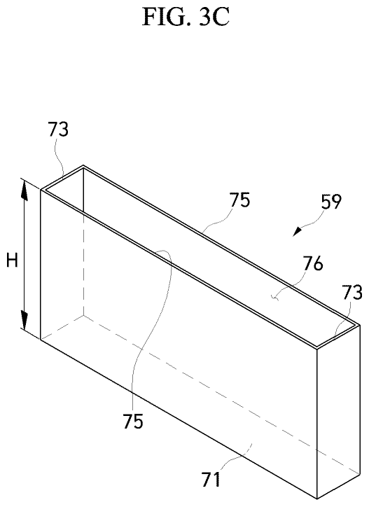

FIGS. 3A to 3C are schematic views of stages in a battery can trimming process.

FIG. 3A shows a semi-finished battery can 59′ made by performing the impact and ironing processes.

Referring to FIG. 3A, the semi-finished battery can 59′ may include a closed portion 71 and side surfaces thereof. The side surfaces may include two facing narrow side surfaces and two facing wide side surfaces. A portion facing (e.g., opposite) the closed portion 71 may be an opening 76 (see FIG. 3C).

In the semi-finished battery can 59′ subjected to the ironing process, surplus portions 72 and 74 that are longer than a required height dimension H (e.g., a design value) may be formed. In the trimming process, the surplus portion 72 needs to be cut. The surplus portion 72 of the narrow side surface may be cut along a cutting line 73, and the surplus portion 74 of the wide side surface may be cut along a cutting line 75.

FIG. 3B shows a state in which the surplus portion 72 of the narrow side surface is removed by being cut along the cutting line 73. FIG. 3C shows a battery can 59 in which both the surplus portion 72 of the narrow side surface and the surplus portion 74 of the wide side surface are cut and trimmed.

Referring to FIGS. 3B and 3C, the battery can has been cleanly trimmed according to the design height H, such that the cutting line 73 of the narrow side surface and the cutting line 75 of the wide side surface may define the edge of the opening 76, and the closed portion 71 may be used as a bottom surface. A battery is manufactured (e.g., completed) after inserting an electrode assembly through the opening 76.

Although FIGS. 3A to 3C show processing processes (impact, ironing, and trimming processes) of a prismatic battery can, a similar processing process may be applied to a cylindrical battery can or a coin-shaped battery can.

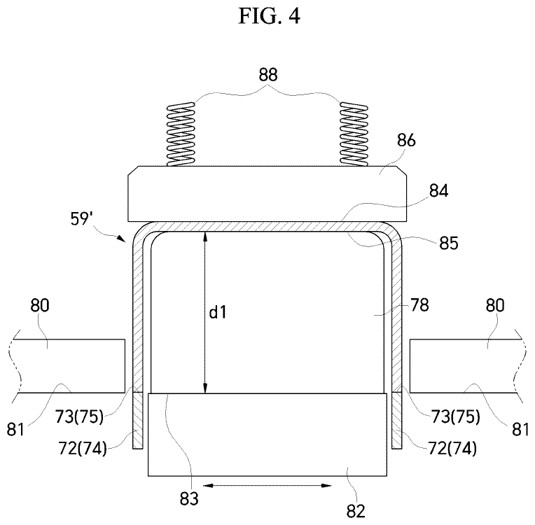

FIG. 4 is an exemplary view of a battery can trimming apparatus, according to example embodiments.

Referring to FIG. 4, to cut the surplus portions 72 and 74 of the ironed semi-finished battery can 59′ along the cutting lines 73 and 75, the semi-finished battery can 59′ may be fitted onto a punch guide 78 so that the opening thereof faces downward, and the surplus portions 72 and 74 may be cut using a die 80 and a transverse punch 82. For example, referring to FIG. 4, the punch guide 78 may protrude through an opening of the die 80 to extend above an upper surface of the die 80, and the transverse punch 82 may be moveable in parallel to and along a bottom surface of the die 80. For example, referring to FIG. 4, the opening of the semi-finished battery can 59′ may be fitted onto the punch guide 78, such that the punch guide 78 extends into the semi-finished battery can 59′ and the surplus portions 72 and 74 extend beyond the bottom surface of the die 80 toward the transverse punch 82, and the transverse punch 82 may cut the surplus portions 72 and 74 extending below the bottom surface of the die 80.

To fix the semi-finished battery can 59′ to the punch guide 78, an inner surface 85 of the closed portion 71 of the semi-finished battery can 59′ may be supported in contact with an upper portion of the punch guide 78, and an outer surface 84 of the closed portion 71 of the semi-finished battery can 59′ may be elastically supported by a lower portion of a support pad 86. The support pad 86 may elastically press the closed portion 71 of the semi-finished battery can 59′ from top to bottom through a spring 88 to come into close contact with the punch guide 78, e.g., so the closed portion 71 of the semi-finished battery can 59′ may be pressed and secured directly between the punch guide 78 and the support pad 86. For example, referring to FIG. 4, the support pad 86 and the punch guide 78 may overlap each other along a longitudinal direction of the punch guide 78, e.g., along the vertical direction.

To secure the height H (see FIG. 3C) of the final battery can 59, a cutting surface 81 of the die 80 (e.g., a lower surface of the die 80) and a cutting surface 83 of the transverse punch 82 (e.g., an upper surface of the transverse punch 82 facing the die 80) may be aligned with the cutting lines 73 and 75 of the semi-finished battery can 59′. For example, referring to FIG. 4, the cutting surface 81 of the die 80 may be aligned with the cutting lines 73 and 75 to be level (e.g., coplanar) with each other, and the cutting surface 83 of the transverse punch 82 may be aligned with the cutting lines 73 and 75 to be level (e.g., coplanar) with each other.

In the case of FIG. 4, the length of the cutting surfaces 81 and 83 may be set to a distance d1 from the inner surface 85 of the closed portion of the semi-finished battery can 59′ to the cutting surfaces 81 and 83, e.g., to adjust alignment of all the surfaces. However, the distance d1 may vary. This is because, since lubricant is supplied to the inside of the battery can due to the nature of the ironing process, flatness may be distorted due to the lubricant remaining inside the battery can or foreign substances mixed with the lubricant. In addition, there may be a problem that the inner surface of the closed portion is scratched by foreign substances during trimming.

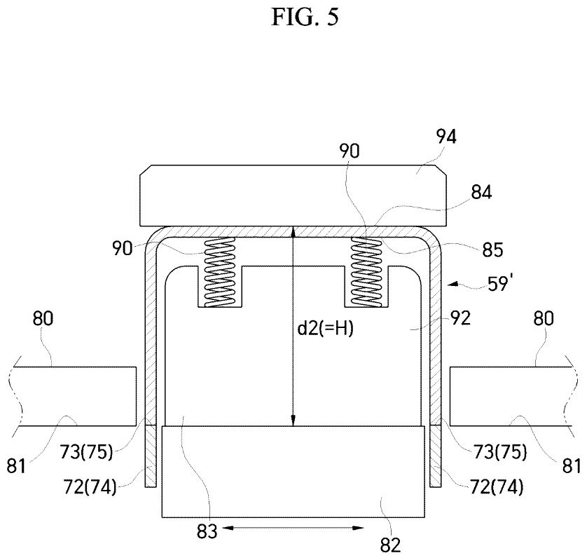

FIG. 5 is an exemplary view of a battery can trimming apparatus, according to other example embodiments.

Referring to FIG. 5, to cut the surplus portions 72 and 74 of the semi-finished battery can 59′ along the cutting lines 73 and 75, the semi-finished battery can 59′ may be placed on (e.g., inserted or insertable into) a punch guide 92 so that the opening thereof faces downward, and the surplus portions 72 and 74 may be cut using the die 80 and the transverse punch 82. Unlike the case of FIG. 4, in placing the semi-finished battery can 59′, the punch guide 92 may be in elastic contact with the inner surface 85 of the closed portion 71 of the semi-finished battery can 59′, and the outer surface 84 may be supported by a support pad 94.

A compression spring 90 may be interposed between the inner surface 85 of the closed portion 71 of the semi-finished battery can 59′ and an upper portion of the punch guide 92 for the elastic contact of the punch guide 92. The support pad 94 may be disposed on the semi-finished battery can 59′ and may function to support the outer surface 84 of the closed portion of the semi-finished battery can 59′.

The cutting surface 81 of the die 80, the cutting surface 83 of the transverse punch 82, and the cutting lines 73 and 75 of the semi-finished battery can 59′ may be aligned, and the length of the cutting surfaces 81 and 83 may be set to a distance d2 from the outer surface 84 of the closed portion of the semi-finished battery can 59′ to the cutting surfaces 81 and 83. This distance d2 is equal to H (see FIGS. 3A and 3C), which is a distance from the outer surface 84 of the closed portion of the final battery can 59 to the cutting lines 73 and 75. Since the distance d2 is not affected by residues of lubricants, foreign substances, or the like used in the ironing process, it is possible to maintain the constant flatness of the final battery can 59, secure accurate design dimensions, and eliminate the possibility of scratches on the inner surface of the closed portion by foreign substances during trimming.

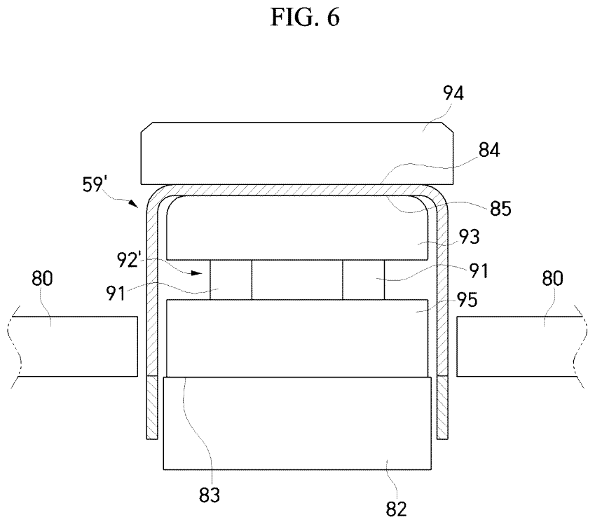

FIG. 6 is an exemplary view of a battery can trimming apparatus, according to still other example embodiments.

The configuration in FIG. 6 may be similar to that in FIG. 5, with the exception that a punch guide 92′ inside the semi-finished battery can 59′ may be divided into a first punch guide 93 at an upper side, which is in contact with the inner surface 85 of the closed portion, and a second punch guide 95 at a lower side, which is in contact with the cutting surface 83 of the punch 82 under the first punch guide 93 and guides the punch 82. The first punch guide and the second punch guide 95 may be connected to each other by an elastic member 91. Since the elastic member 91 is disposed between the first punch guide 93 and the second punch guide 95, the first punch guide 93 may be in elastic contact with the inner surface 85 of the closed portion of the semi-finished battery can 59′.

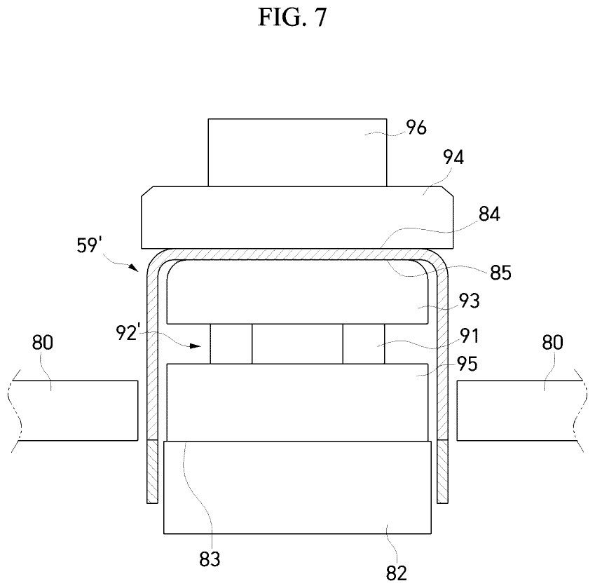

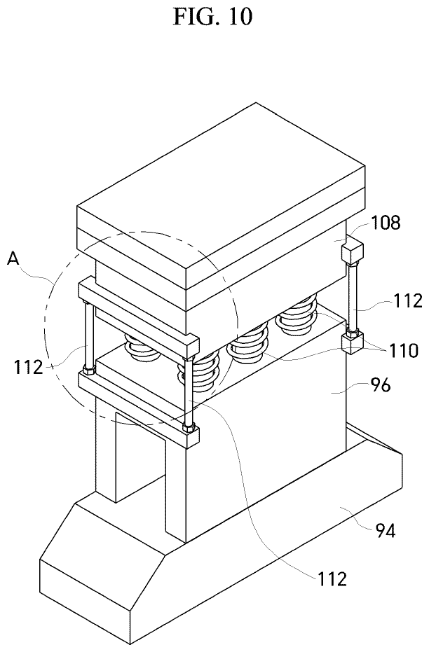

The support pad 94 of the battery can trimming apparatus may be attached to a press device. The press device may be a device on which the battery can trimming apparatus according to some embodiments of the present disclosure is installed. In some other embodiments, a pad holder 96 may be coupled to the support pad 94, as illustrated in FIG. 7, and the pad holder 96 may be connected to the press device. The press device will be described in more detail with reference to FIG. 10 below.

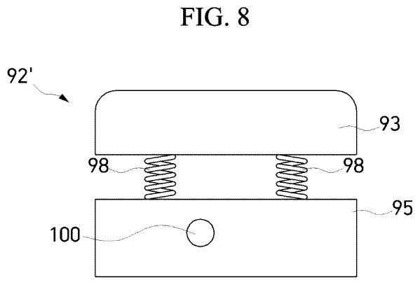

FIG. 8 shows an example of the punch guide 92 divided into the first punch guide 93 and the second punch guide 95. A spring 98 may be used as the elastic member 91 disposed between the first punch guide 93 and the second punch guide 95. A hole 100 formed in the second punch guide 95 may be a hole for detecting whether the semi-finished battery can 59′ is supplied to a correct position of the trimming apparatus for trimming. Whether the hole 100 is blocked may be detected by an optical sensor to determine whether the semi-finished battery can 59′ is supplied.

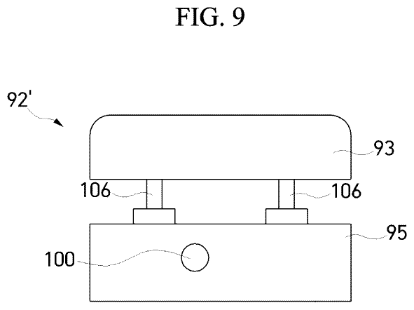

FIG. 9 shows another example of the punch guide 92. A hydraulic cylinder 106 may be used as the elastic member 91 disposed between the first punch guide 93 and the second punch guide 95. The hydraulic cylinder 106 may be operated by a medium such as a pneumatic pressure or hydraulic pressure.

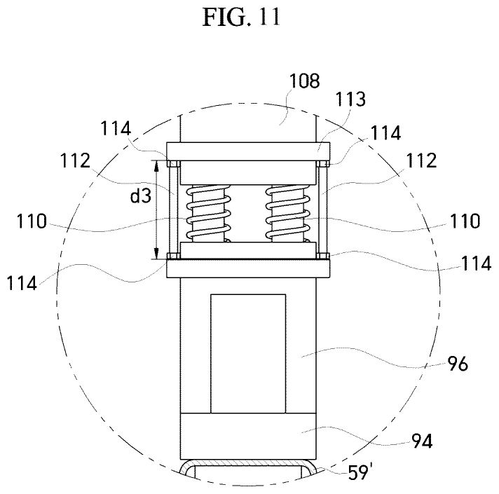

FIG. 10 shows a state in which the pad holder 96 attached to the support pad 94 (e.g., of FIG. 7) is connected to a portion 108 of the press device, and FIG. 11 shows an enlarge view of portion A in FIG. 10.

Referring to FIG. 10, the pad holder 96 may be connected to the portion 108 of the press device, e.g., a connection bracket, through an elastic spring 110. Portion A shown in FIG. 10 is a support pad position adjustment mechanism that adjusts a distance between the support pad 94 and the portion 108 of the press device. Here, the position of the support pad 94 means a distance between the support pad 94 and the press device. To align the cutting surface 81 of the die 80, the cutting surface 83 of the transverse punch 82, and a punch guide surface of the punch guide 92, a distance between the support pad 94 and the trimming device thereunder is important, and thus the support pad position adjustment mechanism may be designed to finely adjust a vertical position of the support pad 94, e.g., so the support pad 94 may be moveable toward and away from the punch guide via the support pad position adjustment mechanism.

If the punch guide were to be divided into an upper piece and a lower piece with a height adjustment spacer therebetween to adjust the position of the support pad 86 (see FIG. 4), a height adjustment range would be limited, and very cumbersome work would be required. In contrast, a support pad position adjustment mechanism according to some embodiments of the present disclosure, as shown in FIG. 11, may include a plurality of bolts 112 connecting the support pad 94 or the pad holder 96 to the portion 108 of the press device or a bracket 113, and nuts 114 coupled to the bolts 112 to adjust a linear distance d3 between the support pad 94 or the pad holder 96 and the portion 108 or the bracket 113 of the press device. The nut 114 may be turned to increase or decrease the linear distance d3, thereby adjusting the distance between the support pad 94 supporting the semi-finished battery can 59′ and the press device.

A battery can trimming method according to some embodiments of the present disclosure will be described. Since the following battery can trimming method may use the battery can trimming apparatus according to the above-described embodiments, detailed descriptions thereof are similar to the above description.

First, the semi-finished battery can may be placed on the trimming apparatus so that the punch guide comes into contact with the inner surface of the closed portion of the semi-finished battery can including the surplus portion to be cut along the cutting line, the closed portion, and the opening. In addition, the outer surface of the closed portion of the semi-finished battery can may be supported by the support pad, and the surplus portion may be cut along the cutting line of the semi-finished battery can using a punch and a die. Here, a cutting line of the surplus portion may be positioned at a predetermined distance from the outer surface of the closed portion of the semi-finished battery can. In addition, each of the cutting surfaces of the die and the punch and the cutting line of the semi-finished battery can may be aligned to be coplanar.

The semi-finished battery can may be placed so that the closed portion is positioned at an upper side and the opening is positioned at a lower side. The distance from the outer surface of the closed portion of the semi-finished battery can to the cutting line may be the same as the design height of the final battery can. In some embodiments, the distance between the support pad and the press device can be adjusted by using a plurality of bolts connecting the support pad to the press device and nuts coupled to the bolts to adjust the linear distance between the support pad and the press device.

The above-described battery can trimming apparatus according to the present disclosure can be used for all battery cans that require a trimming operation following impact and ironing operations. Therefore, the battery can trimming apparatus according to the present disclosure can be applied not only to the prismatic battery of the above-described embodiment, but also to a cylindrical battery and a coin-shaped battery.

By way of summation and review, the present disclosure is directed to trimming of a battery can, such that a flatness distortion after the trimming of the battery can and a scratch occurrence by lubricants and foreign substances supplied inside the battery can due to the nature of an ironing process may be prevented or substantially minimized.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery can trimming apparatus, comprising:
a die with a first opening therethrough;
a punch guide extending through the first opening of the die, the punch guide being configured to be in contact with an inner surface of a closed portion of a semi-finished battery can, and the semi-finished battery can including a surplus portion to be cut along a cutting line, the closed portion, and a second opening;
a support pad above the punch guide, the support pad being configured to support an outer surface of the closed portion of the semi-finished battery can; and
a punch below the die and moveable along a bottom of the die, the punch being configured to cut the surplus portion along the cutting line of the semi-finished battery can, and the cutting line being positioned at a predetermined distance from the outer surface of the closed portion of the semi-finished battery can.

2. The battery can trimming apparatus as claimed in claim 1, wherein:
the support pad and the punch guide overlap each other along a longitudinal direction of the punch guide,
the closed portion and the second opening of the semi-finished battery can are at opposite ends of the semi-finished battery can, the closed portion to be positioned between the support pad and the punch guide, and
the punch guide is insertable through the second opening of the semi-finished battery can to contact the inner surface of the closed portion.

3. The battery can trimming apparatus as claimed in claim 1, wherein a cutting surface of each of the die and the punch is aligned to be coplanar with each other and with the cutting line of the semi-finished battery can.

4. The battery can trimming apparatus as claimed in claim 1, wherein the predetermined distance from the outer surface of the closed portion of the semi-finished battery can to the cutting line is the same as a design height of a final battery can.

5. The battery can trimming apparatus as claimed in claim 1, further comprising a spring between the support pad and the punch guide.

6. The battery can trimming apparatus as claimed in claim 1, wherein the punch guide includes:
a first punch guide in contact with the inner surface of the closed portion; and
a second punch guide below the first punch guide and in contact with a cutting surface of the punch, the second punch being configured to guide the punch.

7. The battery can trimming apparatus as claimed in claim 6, further comprising an elastic member between the first punch guide and the second punch guide.

8. The battery can trimming apparatus as claimed in claim 7, wherein the elastic member is a spring.

9. The battery can trimming apparatus as claimed in claim 7, wherein the elastic member is a hydraulic cylinder.

10. The battery can trimming apparatus as claimed in claim 1, wherein the support pad is connected to a press device.

11. The battery can trimming apparatus as claimed in claim 10, further comprising a support pad position adjustment mechanism configured to adjust a distance between the support pad and the press device.

12. The battery can trimming apparatus as claimed in claim 11, wherein the support pad position adjustment mechanism includes:
a plurality of bolts connecting the support pad to the press device; and
nuts coupled to the bolts to adjust a linear distance between the support pad and the press device.

13. The battery can trimming apparatus as claimed in claim 1, wherein the battery can is a prismatic battery can.

14. The battery can trimming apparatus as claimed in claim 1, wherein the battery can is a cylindrical battery can.

15. A battery can trimming method, comprising:
placing a semi-finished battery can onto a punch guide, such that the punch guide is in contact with an inner surface of a closed portion of the semi-finished battery can, the semi-finished battery can including a surplus portion to be cut along a cutting line, the closed portion, and an opening;
supporting an outer surface of the closed portion of the semi-finished battery can using a support pad;
positioning the cutting line of the surplus portion at a predetermined distance from the outer surface of the closed portion of the semi-finished battery can; and
cutting the surplus portion along the cutting line of the semi-finished battery can using a punch and a die.

16. The battery can trimming method as claimed in claim 15, wherein the closed portion of the semi-finished battery can is positioned at an upper side and the opening is positioned at a lower side.

17. The battery can trimming method as claimed in claim 15, further comprising aligning a cutting surface of each of the die and the punch to be coplanar with the cutting line of the semi-finished battery can.

18. The battery can trimming method as claimed in claim 15, wherein the predetermined distance from the outer surface of the closed portion of the semi-finished battery can to the cutting line is the same as a design height of a final battery can.

19. The battery can trimming method as claimed in claim 15, further comprising adjusting a distance between the support pad and a press device.

20. The battery can trimming method as claimed in claim 19, wherein adjusting the distance between the support pad and the press device is performed using a plurality of bolts connecting the support pad to the press device and nuts coupled to the bolts to adjust a linear distance between the support pad and the press device.
